(19) United States
(12) Patent Application Publication
(10) Pub. No.: US 2024/0027202 A1
(43) Pub. Date: Jan. 25, 2024

(54) SYSTEM AND METHOD FOR MULTIMODAL TRIP PLANNING WITH FIRST MILE AND LAST MILE CONNECTIVITY

(71) Applicant: Transhelp Technologies Private Limited, Bangalore (IN)

(72) Inventors: Narayan Ashok Mishra, Bangalore (IN); Hiranmaya Mallick, Bangalore (IN)

(21) Appl. No.: 18/042,034

(22) PCT Filed: Aug. 19, 2021
(86) PCT No.: PCT/IB2021/057626

§ 371 Date: Feb. 17, 2023

(30) Foreign Application Priority Data
Aug. 19, 2020 (IN) 202041035735
Aug. 19, 2021 (WO) PCT/IB2021/057626

(51) Int. Cl. G01C 21/34; G01C 21/36; G06Q 10/02; G06Q 30/0282; G06Q 50/30

(52) U.S. Cl. CPC G01C 21/3423; G01C 21/343; G01C 21/3617; G01C 21/3691; G06Q 10/02; G06Q 30/0282; G06Q 50/30

(57) ABSTRACT

A system for multimodal trip planning is disclosed. A trip data receiving subsystem to receive a source and destination address associated with a trip from a user. A trip route planning subsystem to plan one or more route options feasible for the trip. A route suggestion subsystem to determine an itinerary associated with corresponding one or more route options, to suggest at least one optimal route option upon determination of the itinerary associated with the corresponding one or more route options based on a plurality of route suggestion rules. A ticket booking subsystem to receive a ticket booking request from the user, to generate a unique code-based ticket to facilitate booking of the one or more transport services encompassed in the at least one optimal route option. A trip feedback generation subsystem to generate a ride score at completion of the trip based on a plurality of ride experience parameters.

### CROSS-REFERENCE TO RELATED APPLICATION

This application claims priority from a patent application filed in India having Patent Application No. 202041035735, filed on Aug. 19, 2020, and titled “SYSTEM AND METHOD FOR MULTIMODAL TRIP PLANNING WITH FIRST MILE AND LAST MILE CONNECTIVITY” and a PCT Application No. PCT/IB2021/057626 filed on Aug. 19, 2021, and titled “SYSTEM AND METHOD FOR MULTIMODAL TRIP PLANNING WITH FIRST MILE AND LAST MILE CONNECTIVITY.”

### BACKGROUND

Embodiments of the present disclosure relate to a trip planning system and more particularly to a system and a method for multimodal trip planning with first mile and last mile connectivity and single ticketing.

Public transportation is a form of travel offered locally within a city or a town that enables people to travel together along designated routes. With gradual development and improvement of the public transportation infrastructure, increased environmental awareness, and rising fuel prices, many people have begun to use various forms of public transport. The various forms of the public transport options include rail, buses, taxis, metros, trams or ferries. Due to this increased use of the public transport, various public transit planning systems have been developed. Such public transit planning systems provide a user or a commuter with instructions for travel from a source location to a destination location via various types of the public transportation options available. Generally, a user's behaviour and traffic analysis considered by the public transit planning systems helps one or more urban planning agencies to better plan and manage infrastructure of the city. Various public transit planning systems are available which defines the best route either using single or multiple modes of travel based on the user's input.

One such type of conventional public transit planning system is available which suggests a same route using a similar mode of travel between a particular source and destination location irrespective of number of times it is searched by the user. However, such a conventional system with static nature of suggestion discourages users as their changing needs and the dynamic nature of transit in cities gets ignored. Also, such conventional system undertakes route optimisation of public transport and trip planning using multimodal transport but miss the critical element of predicting the availability of first and last mile transport options, which, in case of unavailability/unoptimized planning causes an efficient chain of transport to break thus leading to dissatisfaction of the user. Moreover, inefficient and unoptimized planning by the conventional public transit systems results in mismanaged and inefficient operations of the public transports which further create congestions on the road and consumes unnecessary fuel. Furthermore, the congestions on the road due to inefficient operations increases travel time and makes the trip expensive due to maximum fuel consumption.

Hence, there is a need for an improved system and a method for multimodal trip planning with first mile and last mile connectivity in order to address the aforementioned issues.

### BRIEF DESCRIPTION

In accordance with an embodiment of the present disclosure, a system for multimodal trip planning with first mile and last mile connectivity and single ticketing. The system includes a trip data receiving subsystem configured to receive a source address and a destination address associated with a trip from a user. The system also includes a trip route planning subsystem operatively coupled to the trip data receiving subsystem. The trip route planning subsystem is configured to plan one or more route options feasible for the trip in real-time based on the source address and the destination address received. The system also includes a route suggestion subsystem operatively coupled to the trip route planning subsystem. The route suggestion subsystem is configured to determine an itinerary associated with corresponding one or more route options planned between a source and a destination based on at least one of real-time geographical location input, ride cost, estimated time of arrival associated with one or more available transport services, a user preference, weather information or a combination thereof. The route suggestion subsystem is also configured to suggest at least one optimal route option upon determination of the itinerary associated with the corresponding one or more route options based on a plurality of route suggestion rules. The system also includes a ticket booking subsystem operatively coupled to the route suggestion subsystem. The ticket booking subsystem is configured to receive a ticket booking request from the user based on selection of the at least one optimal route option suggested. The ticket booking subsystem is also configured to generate a unique code-based ticket to facilitate booking of the one or more transport services encompassed in the at least one optimal route option based on the ticket booking request received from the user. The system also includes a trip feedback generation subsystem operatively coupled to the ticket booking subsystem and the route suggestion subsystem. The trip feedback generation subsystem is configured to generate a ride score at completion of the trip booked by the user based on comparison of a plurality of ride experience parameters.

In accordance with another embodiment of the present disclosure, a method for multimodal trip planning with first mile and last mile connectivity and single ticketing is disclosed. The method includes receiving a source address and a destination address associated with a trip from a user. The method also includes planning one or more route options feasible for the trip in real-time based on the source address and the destination address received. The method also includes determining an itinerary associated with corresponding one or more route options planned between a source and a destination based on at least one of real-time geographical location input, ride cost, estimated time of arrival associated with one or more available transport services, a user preference, weather information or a combination thereof. The method also includes suggesting at least one optimal route option upon determination of the itinerary associated with the corresponding one or more route options based on a plurality of route suggestion rules. The method also includes receiving a ticket booking request from the user based on selection of the at least one optimal route option suggested. The method also includes generating a unique code-based ticket to facilitate booking of the one or more transport services encompassed in the at least one optimal route option based on the ticket booking request received from the user. The method also includes generating a ride score at completion of the trip booked by the user based on comparison of a plurality of ride experience parameters.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram of a system for multimodal trip planning with first mile and last mile connectivity in accordance with an embodiment of the present disclosure;

FIG. 2 depicts a schematic representation of an embodiment of a ride distribution technique of a system for multimodal trip planning with first mile and last mile connectivity of FIG. 1 in accordance with an embodiment of the present disclosure;

FIG. 3 is a block diagram of an embodiment of a system for multimodal trip planning with first mile and last mile connectivity of FIG. 1 in accordance with an embodiment of the present disclosure;

FIG. 4 is a block diagram of an exemplary system for multimodal trip planning with first mile and last mile connectivity in accordance with an embodiment of the present disclosure;

FIG. 5 illustrates a block diagram of a computer or a server of FIG. 1 in accordance with an embodiment of the present disclosure; and

FIG. 6 is a flow chart representing the steps involved in a method for multimodal trip planning with first mile and last mile connectivity of FIG. 1 in accordance with the embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a system and a method for multimodal trip planning with first mile and last mile connectivity and single ticketing. The system includes a trip data receiving subsystem configured to receive a source address and a destination address associated with a trip from a user. The system also includes a trip route planning subsystem operatively coupled to the trip data receiving subsystem. The trip route planning subsystem is configured to plan one or more route options feasible for the trip in real-time based on the source address and the destination address received. The system also includes a route suggestion subsystem operatively coupled to the trip route planning subsystem. The route suggestion subsystem is configured to determine an itinerary associated with corresponding one or more route options planned between a source and a destination based on at least one of real-time geographical location input, ride cost, estimated time of arrival associated with one or more available transport services, a user preference, weather information or a combination thereof. The route suggestion subsystem is also configured to suggest at least one optimal route option upon determination of the itinerary associated with the corresponding one or more route options based on a plurality of route suggestion rules. The system also includes a ticket booking subsystem operatively coupled to the route suggestion subsystem. The ticket booking subsystem is configured to receive a ticket booking request from the user based on selection of the at least one optimal route option suggested. The ticket booking subsystem is also configured to generate a unique code-based ticket to facilitate booking of the one or more transport services encompassed in the at least one optimal route option based on the ticket booking request received from the user. The system also includes a trip feedback generation subsystem operatively coupled to the ticket booking subsystem and the route suggestion subsystem. The trip feedback generation subsystem is configured to generate a ride score at completion of the trip booked by the user based on comparison of a plurality of ride experience parameters.

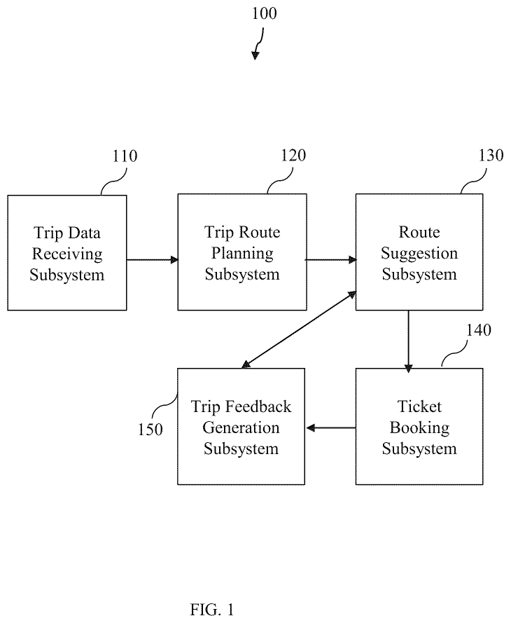

FIG. 1 is a block diagram of a system 100 for multimodal trip planning with first mile and last mile connectivity in accordance with an embodiment of the present disclosure. The system 100 includes a trip data receiving subsystem 110 configured to receive a source address and a destination address associated with a trip from a user. In one embodiment, the source address and the destination address from the user may be received in one or more formats, wherein the one or more formats may include, but not limited to, a text format, a voice format and the like. In such embodiment, the source address and the destination address data in the one or more formats may be received via an electronic device associated with the user. In such embodiment the electronic device may include, but not limited to, a mobile phone, a desktop, a laptop, a tablet, a personal digital assistant (PDA) and the like. As used herein, the term ‘source address’ is defined as an originating point or a pickup location of the trip for the user. Similarly, the term ‘destination address’ is defined as a final point or the dropping point of the trip for the user.

The system 100 also includes a trip route planning subsystem 120 operatively coupled to the trip data receiving subsystem 110. The trip route planning subsystem 120 is configured to plan one or more route options feasible for the trip in real-time based on the source address and the destination address received. In one embodiment, the one or more route options may include at least one of a direct route option, a public transit route option, a first mile and a last mile route option or a combination thereof. As used herein, the term ‘direct route option’ is defined as a direct route without transit option available between the source location and the destination location. In one embodiment, the direct route option may include a taxi service from the source location to the destination location. In another embodiment, the public transit route option for reaching the destination location may include, but not limited to, a metro service, a suburban railway service, a tram service, a bus service, a ferry service or a combination thereof. In another embodiment, the first mile and the last mile route option may include at least one of a cab service, an autorickshaw service, a ridesharing motorbike service, a ride sharing scooter service, a bicycle service, a shuttle-van service, walking or a combination thereof. In one embodiment, the trip route planning subsystem 120 may plan the one or more route options to book a ride for the user, an acquaintance of the user, a family member of the user or a relative of the user.

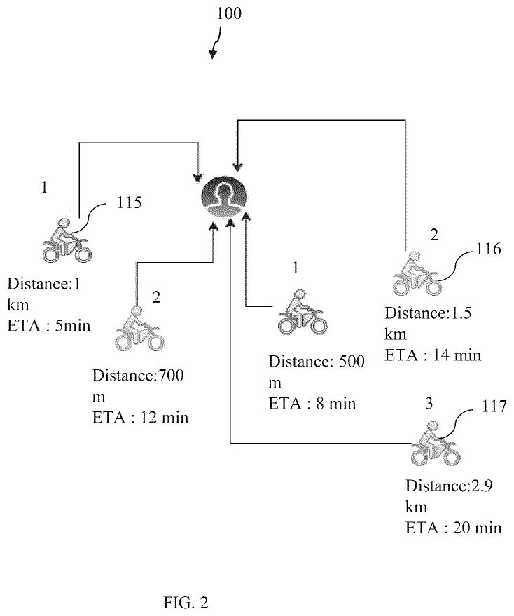

The system 100 also includes a route suggestion subsystem 130 operatively coupled to the trip route planning subsystem 120. The route suggestion subsystem 130 is configured to determine an itinerary associated with corresponding one or more route options planned between a source and a destination based on at least one of real-time geographical location input, ride cost, estimated time of arrival (ETA) associated with one or more available transport services, a user preference, weather information or a combination thereof. In one embodiment, the route suggestion subsystem may include a web service running in a remote server hosted in cloud environment. In another embodiment, the route suggestion subsystem 130 as the web service may be located on a local server. In a specific embodiment, the geographical location input may include a global positioning location data of a vehicle. In another embodiment, the geographical location input may include a user's geographical location. The user's geographical location is derived through machine learning model which predicts the ETA at a given point on the route using historic/previous GPS data, traffic data, weather information considering buffer error rate and the like. In a particular embodiment, the route suggestion subsystem 130 determines the ETA associated with one or more available transport services of the first mile and the last mile route option using a ride distribution technique. One such schematic representation of working of a ride distribution technique is depicted in FIG. 2.

FIG. 2 depicts a schematic representation of an embodiment of a ride distribution technique of FIG. 1 in accordance with an embodiment of the present disclosure. The ride distribution technique determines the one or more transport services available in different areas by identifying one or more drivers available within a predefined distance based on traffic and weather conditions. The ride distribution technique also determines a priority order associated with availability of one or more identified drivers within the predefined distance. Once, the priority order is determined, the ride distribution technique is also utilized in creating one or more priority groups corresponding to the priority order based on estimated time arrival of one or more identified drivers, driver's rating and a user preference. Further, the ride distribution technique broadcasts a booking request to the one or more priority groups based on the priority order to obtain a booking response. In one embodiment, the booking response may include a successful booking response or an unsuccessful booking response. In such embodiment, the successful booking response may include an acceptance of the booking request by the one or more drivers belonging to the first priority group 115. In another embodiment, the unsuccessful booking response may include unacceptance of the booking request by the one or more drivers belonging to the first priority group. In such embodiment, the unsuccessful booking response may be broadcasted from the first priority group to a subsequent priority group such as a second priority group 116, a third priority group 117 and the like within a continuous time interval.

The route suggestion subsystem 130 is also configured to suggest at least one optimal route option upon determination of the itinerary associated with the corresponding one or more route options based on a plurality of route suggestion rules. In one embodiment, the plurality of route suggestion rules may include at least one of a user commute preference, a previous ride score, a cheapest route, a fastest route or a combination thereof. In such embodiment, the user commute preference may include, but not limited to, walking preference for a predetermined distance, cycling preference for a predetermined distance, direct ride preference, transit ride preference, waiting time preference and the like.

In another embodiment, the previous ride score may include a highest ride score computed based on a ride experience of the user in his or her past ride. In yet another embodiment, the cheapest route may include a route with least combined cost for one or more modes of travel. In one embodiment, the fastest route may include a route with least combined travel time irrespective of the associated cost.

The system 100 also includes a ticket booking subsystem 140 operatively coupled to the route suggestion subsystem 130. The ticket booking subsystem 140 is configured to receive a ticket booking request from the user based on selection of the at least one optimal route option suggested. The ticket booking subsystem 140 is also configured to generate a unique code-based ticket to facilitate booking of the one or more transport services encompassed in the at least one optimal route option based on the ticket booking request received from the user. In one embodiment, the unique code-based ticket may include a single quick response (QR) code-based ticket with a ticket identity number (id). The unique code-based ticket id is utilized for booking of the one or more transport services. In such embodiment, the one or more transport services may include the one or more transport services associated with the first mile route option, the direct route option, the public transit route option and the last mile route option. In a specific embodiment, booking information associated with the ticket booked for the one or more transport services may be stored in a service provider's database hosted on a centralised server. The single unique code-based ticket booked for the one or more transport services are further verified and validated by one or more corresponding transport service providers upon fetching the booking information associated with the ticket from the centralised server.

The system 100 also includes a trip feedback generation subsystem 150 operatively coupled to the ticket booking subsystem 140 and the route suggestion subsystem 130. The trip feedback generation subsystem 150 is configured to generate a ride score at completion of the trip booked by the user based on comparison of a plurality of ride experience parameters. In one embodiment, the ride score may include a single point score on a scale of 1-5. In one embodiment, the plurality of ride experience parameters may include at least one of an estimated ticket cost, an actual ticket cost, an estimated travel time, an actual travel time, an availability of first mile option, an availability of last mile option, a preciseness of transit time or a combination thereof. In such embodiment, a prediction model predicts the ride score based on comparison of the actual data and the estimated data.

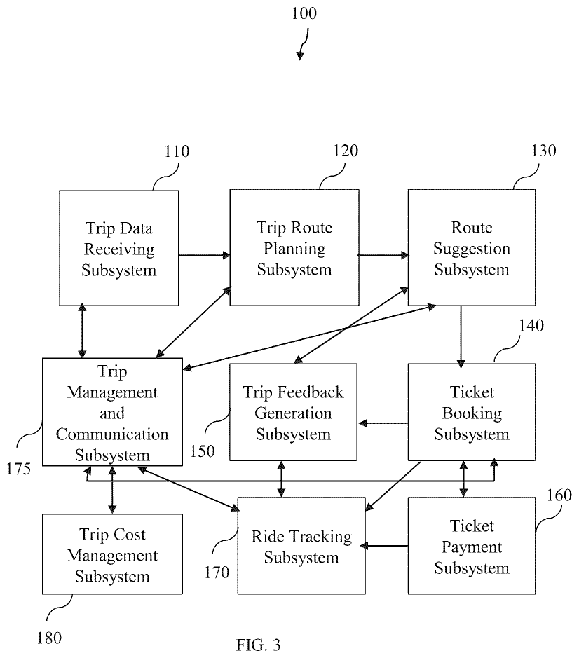

FIG. 3 is a block diagram of an embodiment of a system 100 for multimodal trip planning with first mile and last mile connectivity of FIG. 1 in accordance with an embodiment of the present disclosure. As described in aforementioned FIG. 1, the system 100 includes a trip data receiving subsystem 110, a trip route planning subsystem 120, a route suggestion subsystem 130, a ticket booking subsystem 140 and a trip feedback generation subsystem 150. In one embodiment, the system 100 further includes a ticket payment subsystem 160 operatively coupled to the ticket booking subsystem 140. The ticket payment subsystem 150 is configured to initiate payment for booking of each of the one or more transport services via a payment gateway based on a single unique code-based ticket generated. The ticket payment subsystem 160 initiates the payment for each of the one or more transport services in parallel and upon confirmation of the payment creates the same ticket for each leg of transit.

In a particular embodiment, the system 100 further includes a ride tracking subsystem 170 operatively coupled to the ticket payment subsystem 160. The ride tracking subsystem 170 is configured to track each leg of the ride booked by the user in real-time based on tracking of geo-coordinates of the user's location and the vehicle's location at completion of the each leg of the journey using the unique code-based ticket generated. A ticket identity number and the single unique code of the ticket scanned by the ride tracking subsystem 170 enables tracking of first mile ride, a direct ride, a public transit ride and a last mile ride in real-time.

In a specific embodiment, the system further includes a trip management and communication subsystem 175 configured to communicate among one or more transport service provides to keep record of updated information associated with the one or more transport services. The trip management and communication subsystem 175 pulls latest information from the one or more transport service providers and keeps track of latest information and updates a transport service provider's database based on a predetermined requirement. The data stored in the transport service provider's database enables the route suggestion subsystem 130 to suggest an optimal route to the user. For example, the updated information in the database aggregated from the one or more transport service providers helps in case of a change in bus routes, change in fare, change in set of drivers, availability of number of new routes and the like.

In a particular embodiment, the system further includes a trip cost management subsystem 180 configured to compute a commute cost associated with the at least one route option for suggestion of an optimal route to the user. In such embodiment, the commute cost is computed based on average of the cost associated with the at least one route option available in a city. For example, the commute cost is computed based on consideration of the cost associated with the direct route option, the first mile route option, the last mile route option and the public transit route option. Also, the commute cost is calculated considering the probability of the available and most frequent commute options taken by the user. Further, the cost associated with the direct route option and a multimodal route option by combining the first mile route option, the last mile route option and the public transit route option are compared with each other to suggest a cost-effective and optimal route to the user.

In one embodiment, the trip cost management subsystem 180 further computes carbon cost associated with the at least one route option for suggestion of an optimal route to the user. As used herein, the term ‘carbon cost’ is defined as cost associated with emission of carbon from a vehicle through the at least one route option. The probability of carbon saving through multimodal route option is higher as the trip cost management subsystem 180 considers manages the trip through the best possible public transport options which emits less carbon and the short distance first and last mile connectivity through the one or more transport services available.

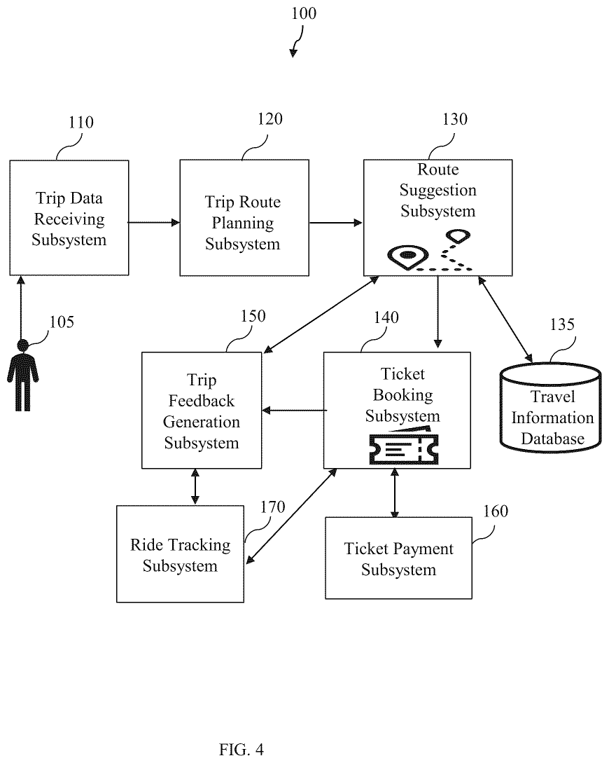

FIG. 4 is a block diagram of an exemplary system for multimodal trip planning with first mile and last mile connectivity in accordance with an embodiment of the present disclosure. The system 100 helps in providing an end to end transportation service for daily commutation needs of one or more daily commuters using reliable public transportation. For example, let us assume, that a commuter ‘X’ 105 wants to travel from a place ‘A’ of a city to place ‘B’ for shopping using the public transportation service. In the example used herein, the place ‘A’ refers to a place of residence of the commuter ‘X’ 105 which is the source address. Similarly, the place ‘B’ refers to a shopping hub of the city which is the destination location. Now, in order to initiate a trip between the place ‘A’ and ‘B’, the commuter ‘X’ 105 through an electronic handheld device needs to provide only the source address and the destination address in one or more formats, wherein the one or more formats may include a text format or a voice format. For example, the electronic handheld device may include a mobile phone associated with the commuter 105. The address data provided by the commuter ‘X’ 105 is received by a trip data receiving subsystem 110.

Once the input related to the address from the commuter ‘X’ is received, a trip route planning subsystem 120 plans one or more route options feasible for the trip in real-time. Suppose if the commuter ‘X’ 105 is unaware about an availability of metro service between the source address and a nearest point of the destination address, in such a scenario, the trip route planning subsystem 120 for better public transport adoption and for building trust on public transport systems, plans the one or more route options which may include at least one of a direct route option, a first mile and a last mile route option or a combination thereof. For example, the direct route option for reaching the destination location may include, but not limited to, a metro service, a suburban railway service, a tram service, a bus service, a ferry service or a combination thereof. Again, the first mile and the last mile route option may include at least one of a cab service, an autorickshaw service, a ridesharing motorbike service, a ride sharing scooter service, a bicycle service, a shuttle-van service, walking or a combination thereof.

Upon planning of the one or more route options, a route suggestion subsystem 130 determines an itinerary associated with corresponding one or more route options planned between a source and a destination based on at least one of real-time geographical location input, ride cost, estimated time of arrival (ETA) associated with one or more available transport services, a user preference, weather information or a combination thereof. Here the itinerary is determined for analysis of several factors in choosing and suggesting an optimal route option to the commuter ‘X’ 105. For example, the real-time geographical location input may include a global positioning location data of a vehicle or a user's geographical location. The user's geographical location data is derived through machine learning model which predicts the ETA at a given point on the route using historic/previous GPS data, traffic data considering buffer error rate and the like. Also, the ETA in real-time is calculated based on the actual geographical location data.

So, for checking the itinerary corresponding to the first mile and the last mile route option, the route suggestion subsystem 130 determines the ETA associated with one or more available transport services in the first mile and the last mile route option using a ride distribution technique. The ride distribution technique determines the one or more transport service available in different areas by identifying one or more drivers available within a predefined distance based on traffic and weather conditions. The ride distribution technique also determines a priority order associated with availability of one or more identified drivers within the predefined distance. Once, the priority order is determined, the ride distribution technique is also utilized in creating one or more priority groups corresponding to the priority order based on estimated time arrival of one or more identified drivers, driver's rating and a user preference. Further, the ride distribution technique broadcasts a booking request to the one or more priority groups based on the priority order to obtain a booking response. For example, the booking response may include a successful booking response or an unsuccessful booking response. Thus, the route suggestion subsystem 130 is able to identify the time involved, the cost involved, and travel distance involved while travelling by using the first mile and the last mile route option. Also, the route suggestion subsystem 130 determines the itinerary corresponding to the direct route option.

Further, the route suggestion subsystem 130 suggests at least one optimal route option upon determination of the itinerary associated with the corresponding one or more route options based on a plurality of route suggestion rules. For example, the plurality of route suggestion rules may include at least one of a user commute preference, a previous ride score, a cheapest route, a fastest route or a combination thereof. Here, the user commute preference may include, but not limited to, walking preference for a predetermined distance such as 500 metre (m), cycling preference for a predetermined distance such as 1.5 kilometre (km), direct ride preference without any transit, transit ride preference such as cab or auto, waiting time preference and the like.

Once, the optimal route is suggested to the commuter 105, a ticket booking subsystem 140 based on a ticket booking request received from the commuter, initiates reservation for one or more transport services encompassed in the at least one optimal route option. The ticket booking subsystem 140 connects with a travel information database 135 to fetch information associated with the one or more transport service providers for the first mile route option, the direct ride option, the public transit route option and the last mile ride option. The ticket booking subsystem 140 generates a unique code-based ticket to facilitate booking of the one or more transport services encompassed in the at least one optimal route option. In the example used herein, the unique code-based ticket may include a single quick response (QR) code-based ticket with a ticket identity number (id). Again, upon generation of the unique code for the ticket, a ticket payment subsystem 160 initiates a payment for booking of each of the one or more transport services via a payment gateway. The ticket payment subsystem 160 initiates the payment for each of the one or more transport services in parallel and upon confirmation of the payment creates the same ticket for each leg of transit. For example, the payment gateway may include an online payment service provided by a payment service provider. Upon confirmation of the payment, the single ticket with the unique QR code and the ticket id gets booked for utilization of the one or more transport services for each leg of transit.

Further, upon scanning of the same unique code-based ticket, a ride tracking subsystem 170 is able to track each leg of the ride booked by the user in real-time. The ride tracking subsystem 170 enables tracking of first mile ride, a transit ride and a last mile ride in real-time. Also, in order to improve the suggestion of the route for future scenarios, a trip feedback generation subsystem 150 generates a ride score at completion of the trip booked by the user based on comparison of a plurality of ride experience parameters. In the example used herein, the plurality of ride experience parameters may include at least one of an estimated ticket cost, an actual ticket cost, an estimated travel time, an actual travel time, an availability of first mile option, an availability of last mile option, a preciseness of transit time or a combination thereof. The trip feedback generation subsystem 150 utilizes a prediction model based one machine learning technology to predict the ride score based on comparison of the actual data and the estimated data. Thus, an end to end system 100 with the single unique code-based ticket with the first mile and the last connectivity helps in an optimized and efficient trip planning for the commuter without any hinderance.

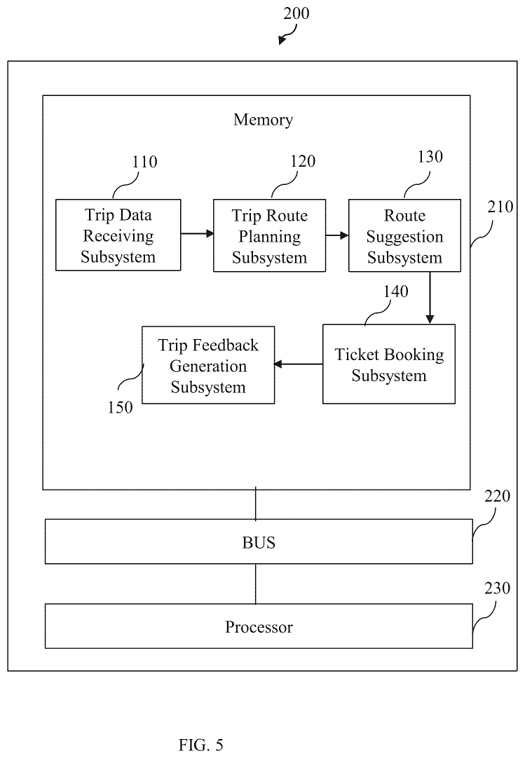

FIG. 5 illustrates a block diagram of a computer or a server of FIG. 1 in accordance with an embodiment of the present disclosure. The server 200 includes processor(s) 230, and memory 210 operatively coupled to the bus 220. The processor(s) 230, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The memory 210 includes several subsystems stored in the form of executable program which instructs the processor 230 to perform the method steps illustrated in FIG. 1. The memory 210 is substantially similar to a system 100 of FIG. 1. The memory 210 has following subsystem: a trip data receiving subsystem 110, a trip route planning subsystem 120, a route suggestion subsystem 130, a ticket booking subsystem 140 and a trip feedback generation subsystem 150.

The trip data receiving subsystem 110 configured to receive a source address and a destination address associated with a trip from a user. The trip route planning subsystem 120 to plan one or more route options feasible for the trip in real-time based on the source address and the destination address received. The route suggestion subsystem 130 is configured to determine an itinerary associated with corresponding one or more route options planned between a source and a destination based on at least one of real-time geographical location input, ride cost, estimated time of arrival associated with one or more available transport services, a user preference, weather information or a combination thereof. The route suggestion subsystem 130 is also configured to suggest at least one optimal route option upon determination of the itinerary associated with the corresponding one or more route options based on a plurality of route suggestion rules. The ticket booking subsystem 140 is configured to receive a ticket booking request from the user based on selection of the at least one optimal route option suggested. The ticket booking subsystem 140 is also configured to generate a unique code-based ticket to facilitate booking of the one or more transport services encompassed in the at least one optimal route option based on the ticket booking request received from the user. The trip feedback generation subsystem 150 to generate a ride score at completion of the trip booked by the user based on comparison of a plurality of ride experience parameters.

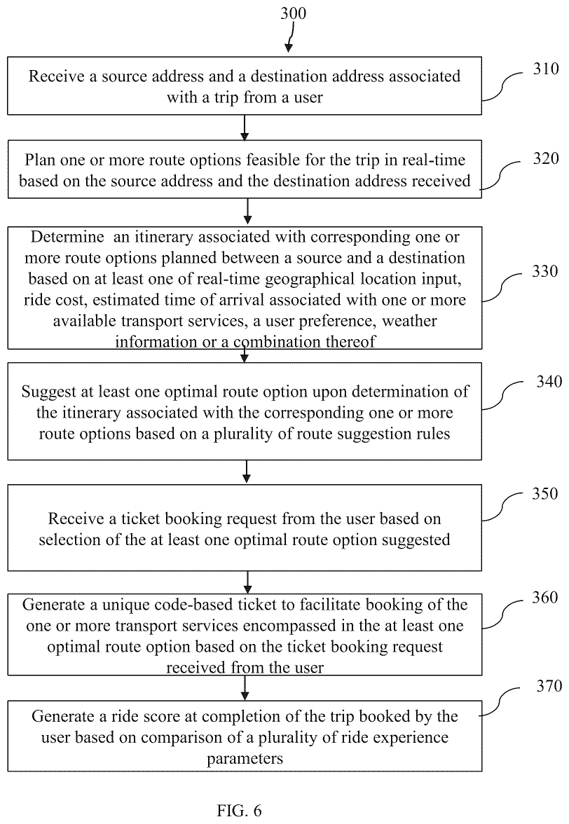

FIG. 6 is a flow chart representing the steps involved in a method 300 for multimodal trip planning with first mile and last mile connectivity of FIG. 1 in accordance with the embodiment of the present disclosure. The method 300 includes receiving a source address and a destination address associated with a trip from a user in step 310. In one embodiment, receiving the source address and the destination address associated with the trip may include receiving the source address and the destination address from the user in one or more formats, wherein the one or more formats may include, but not limited to, a text format, a voice format and the like. In such embodiment, receiving the source address and the destination address data in the one or more formats may include receiving the source address and the destination address data via an electronic device associated with the user.

The method 300 also includes planning one or more route options feasible for the trip in real-time based on the source address and the destination address received in step 320. In one embodiment, planning the one or more route options feasible for the trip may include planning the one or more route options which may include at least one of a direct route option, a first mile and a last mile route option or a combination thereof.

The method 300 also includes determining an itinerary associated with corresponding one or more route options planned between a source and a destination based on at least one of real-time geographical location input, ride cost, estimated time of arrival associated with one or more available transport services, a user preference, weather information or a combination thereof in step 330. In one embodiment, determining the one or more route options planned between the source and the destination may include determining the ETA associated with one or more available transport services of the first mile and the last mile route option using a ride distribution technique. In such embodiment, the ride distribution technique determines the one or more transport service available in different areas by identifying one or more drivers available within a predefined distance based on traffic and weather conditions. The ride distribution technique also includes determining a priority order associated with availability of one or more identified drivers within the predefined distance. The ride distribution technique also includes creating one or more priority groups corresponding to the priority order based on estimated time arrival of one or more identified drivers, driver's rating and a user preference. The ride distribution technique also includes broadcasting a booking request to the one or more priority groups based on the priority order to obtain a booking response. In one embodiment, the booking response may include a successful booking response or an unsuccessful booking response.

The method 300 also includes suggesting at least one optimal route option upon determination of the itinerary associated with the corresponding one or more route options based on a plurality of route suggestion rules in step 340. In one embodiment suggesting the at least one optimal route option may include suggesting the at least one optimal route option based on the plurality of route suggestion rules which may include at least one of a user commute preference, a previous ride score, a cheapest route, a fastest route or a combination thereof.

The method 300 also includes receiving a ticket booking request from the user based on selection of the at least one optimal route option suggested in step 350. The method 300 also includes generating a unique code-based ticket to facilitate booking of the one or more transport services encompassed in the at least one optimal route option based on the ticket booking request received from the user in step 360. In one embodiment, generating the unique code-based ticket to facilitate booking of the one or more transport services may include generating a single quick response (QR) code-based ticket with a ticket identity number (id). In such embodiment, generating the unique code-based ticket may include generating the unique code-based ticket to facilitate booking of the one or more transport services such as the one or more transport services associated with the first mile route option, the direct route option and the last mile route option.

The method 300 also includes generating a ride score at completion of the trip booked by the user based on comparison of a plurality of ride experience parameters in step 370. In one embodiment, generating the ride score at the completion of the trip may include generating the ride score based on the plurality of ride experience parameters which may include at least one of an estimated ticket cost, an actual ticket cost, an estimated travel time, an actual travel time, an availability of first mile option, an availability of last mile option, a preciseness of transit time or a combination thereof.

Various embodiments of the present disclosure provide an end to end system for trip planning with dynamic route suggestions by taking into account total travel time, total travel cost, number of transits, previous ride history and user preference and the like. By consideration of several factors, the system helps in efficient as well as optimised route planning for the commuter which is both time saving as well as cost effective.

Moreover, the present disclosed system utilizes a single unique code-based ticket for booking the one or more transport services in the first mile as well as the last mile ride option which further reduces effort of repetitive ticket booking for multiple transport services and also avoids requirement of multiple payments corresponding to the multiple tickets.

Furthermore, the present disclosed system generates a ride score for the trip using a prediction model even when commuters does not provide any scores and thus helps in providing a feedback for future route suggestions.

In addition, the present disclosed system by providing the optimal route option helps in improving commuters experience, saves commuter's time, saves carbon footprint, reduces congestion on road and results in better public transport adoption due to the trust built on public transport systems.

It will be understood by those skilled in the art that the foregoing general description and the following detailed description are exemplary and explanatory of the disclosure and are not intended to be restrictive thereof.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. A system for multimodal trip planning with first mile and last mile connectivity comprising:
a trip data receiving subsystem configured to receive a source address and a destination address associated with a trip from a user;
a trip route planning subsystem operatively coupled to the trip data receiving subsystem, wherein the trip route planning subsystem is configured to plan one or more route options feasible for the trip in real-time based on the source address and the destination address received;
a route suggestion subsystem operatively coupled to the trip route planning subsystem, wherein the route suggestion subsystem is configured to:
determine an itinerary associated with corresponding one or more route options planned between a source and a destination based on at least one of real-time geographical location input, ride cost, estimated time of arrival associated with one or more available transport services, a user preference, weather information or a combination thereof; and
suggest at least one optimal route option upon determination of the itinerary associated with the corresponding one or more route options based on a plurality of route suggestion rules;
a ticket booking subsystem operatively coupled to the route suggestion subsystem, wherein the ticket booking subsystem is configured to:
receive a ticket booking request from the user based on selection of the at least one optimal route option suggested; and
generate a unique code-based ticket to facilitate booking of the one or more transport services encompassed in the at least one optimal route option based on the ticket booking request received from the user; and
a trip feedback generation subsystem operatively coupled to the ticket booking subsystem and the route suggestion subsystem, wherein the trip feedback generation subsystem is configured to generate a ride score at completion of the trip booked by the user based on comparison of a plurality of ride experience parameters.

2. The system as claimed in claim 1, wherein the one or more route options comprises at least one of a direct route option, a public transit route option, a first mile and a last mile route option or a combination thereof.

3. The system as claimed in claim 2, wherein the first mile and the last mile route options comprises at least one of a cab, an auto, a ridesharing motorbike, a ride sharing scooter, a bicycle, walking or a combination thereof.

4. The system as claimed in claim 1, wherein the route suggestion subsystem is configured to determine a first mile and a last mile route option using a ride distribution technique.

5. The system as claimed in claim 4, wherein the route suggestion subsystem utilizes the ride distribution technique for determination of the first mile and the last mile route option by:
identifying one or more drivers available within a predefined distance based on traffic and weather conditions;
determining a priority order associated with availability of one or more identified drivers within the predefined distance;
creating one or more priority groups corresponding to the priority order based on estimated time arrival of one or more identified drivers, predicted estimated time of arrival by a learning model, driver's rating and a user preference; and
broadcasting a booking request to the one or more priority groups based on the priority order to obtain a booking response.

6. The system as claimed in claim 1, wherein the plurality of route suggestion rules comprises at least one of a user commute preference, a previous ride score, a cheapest route, a fastest route or a combination thereof.

7. The system as claimed in claim 1, comprising a ticket payment subsystem operatively coupled to the ticket booking subsystem, wherein the ticket payment subsystem is configured to initiate payment for booking of each of the one or more transport services via a payment gateway based on a single unique code-based ticket generated.

8. The system as claimed in claim 1, comprising a ride tracking subsystem operatively coupled to the ticket payment subsystem, wherein the ride tracking subsystem is configured to track each leg of the ride booked by the user in real-time using the unique code-based ticket generated.

9. The system as claimed in claim 1, wherein the plurality of ride experience parameters comprises at least one of an estimated ticket cost, an actual ticket cost, an estimated travel time, an actual travel time, an availability of first mile option, an availability of last mile option, a preciseness of transit time or a combination thereof.

10. A method comprising:
receiving, by a trip data receiving subsystem, a source address and a destination address associated with a trip from a user;
planning, by a trip route planning subsystem, one or more route options feasible for the trip in real-time based on the source address and the destination address received;
determining, by a route suggestion subsystem, an itinerary associated with corresponding one or more route options planned between a source and a destination based on at least one of real-time geographical location input, ride cost, estimated time of arrival associated with one or more available transport services, a user preference, weather information or a combination thereof;
suggesting, by the route suggestion subsystem, at least one optimal route option upon determination of the itinerary associated with the corresponding one or more route options based on a plurality of route suggestion rules;
receiving, by a ticket booking subsystem, a ticket booking request from the user based on selection of the at least one optimal route option suggested;
generating, by the ticket booking subsystem, a unique code-based ticket to facilitate booking of the one or more transport services encompassed in the at least one optimal route option based on the ticket booking request received from the user; and
generating, by a trip feedback generation subsystem, a ride score at completion of the trip booked by the user based on comparison of a plurality of ride experience parameters.
